(19) United States
(12) Patent Application Publication
(10) Pub. No.: US 2026/0319178 A1
(43) Pub. Date: Oct. 15, 2026

(54) HETEROGENEOUSLY INTEGRATED PHOTONIC CIRCUITS AND DEVICES FOR LIGHT EMISSION IN FAR-UVC SPECTRUM

(71) Applicant: Uviquity, Inc., Raleigh, NC (US)

(72) Inventors: Wei Jiang, Vestal, NY (US); John Carlson, Raleigh, NC (US); James Carter, Chapel Hill, NC (US); Brent Fisher, Bethesda, MD (US); Scott Burroughs, Raleigh, NC (US)

(21) Appl. No.: 19/645,555

(22) Filed: Apr. 13, 2026

Related U.S. Application Data
(60) Provisional application No. 63/789,247, filed on Apr. 15, 2025.

(51) Int. Cl. G02B 6/126; G02B 6/12

(52) U.S. Cl. CPC G02B 6/126; G02B 2006/12116; G02B 2006/12121; G02B 2006/12128; G02B 2006/12135

(57) ABSTRACT

A photonic integrated circuit (PIC) includes a substrate, a light emitting element comprising a first material on the substrate, and an optical structure comprising a second material on the substrate. The light emitting element is configured to generate light of a first frequency or wavelength range. The optical structure is optically coupled to the light emitting element to receive the light of the first frequency or wavelength range therefrom, and comprises a nonlinear optical element that is configured to generate far UVC light of a second frequency or wavelength range. The optical structure further comprises a transition element that is tapered between a first width adjacent to the light emitting element and a second width distal from the light emitting element and/or a polarization management element that is configured to alter a first polarization of the light received from the light emitting element to a second polarization.

### CLAIM OF PRIORITY

This application claims priority from U.S. Provisional Patent Application No. 63/789,247 entitled “HETEROGENEOUSLY INTEGRATED PHOTONIC CIRCUITS AND DEVICES FOR LIGHT EMISSION IN FAR-UVC SPECTRUM” filed Apr. 15, 2025, in the United States Patent and Trademark Office, the disclosure of which is incorporated by reference herein in its entirety.

### FIELD

The present application is directed to UV light sources, and in particular, to far-UVC light sources and related devices and methods.

### BACKGROUND

Compact and efficient ultraviolet (UV) light sources in the wavelength range of about 200 nanometers (nm) to about 400 nm may be desirable for many applications. For example, UV lasers may be used for lithography in semiconductor manufacturing. Another application is the detection and classification of materials and substances, such as in spectroscopy. Photons in the UV-C (or UVC) wavelength range (e.g., about 200 nm to about 280 nm) can be used to disinfect airborne and surface disease-causing pathogens, while photons in the far end of the UVC wavelength range (also referred to as far-UVC light) may be safe for human exposure. For example, far-UVC light (from about 200 nm to about 240 nm, e.g., from 200 nm to 230 nm) may not penetrate through the dead-cell layer of the skin surface or the tear layer of the human eye, but may be effective against bacteria and viruses. In particular, far-UVC light can efficiently cause permanent physical damage to DNA and proteins, which can prevent bacteria, viruses and fungi from replicating. Human-safe far-UVC light can thus effectively kill disease causing pathogens with little to no risk to humans because these wavelengths may be largely absorbed by the stratum corneum (the top layer of dead skin cells in the epidermis).

However, operation in the far-UVC wavelength range may present challenges. For example, few available light sources may be configured for operation in the far-UVC. Some conventional UV light sources have been implemented by gas-based lamps. One class of such lamps is called “excimer” (excited dimer) lamps that employ a mixture of a reactive gas (such as F₂ or Cl₂) and an inert gas (such as Kr, Ar or Xe) as an active medium. The gas mixtures, when electrically excited, produce a pseudo-molecule with an energy level configuration that allows the generation of specific ultraviolet laser wavelengths. For example, some krypton chloride (KrCl) excimer lamps may directly emit light at a wavelength of 222 nm. However, the bulk or volume, expensive gases, fragile glass enclosures, large power consumption, low efficiency, and short lifetime of such devices may be prohibitive for use in many applications. Moreover, the KrCl light emission wavelength may not be directly tuned, such that optical filters may be required to block or remove non-human safe light wavelengths outside of the 200 nm to 230 nm window, and only a portion of the emission spectrum may be output within the target window of the far-UVC wavelength range.

Also, high power, ultrafast laser systems designed for laboratory use can provide non-linear harmonic generation (e.g., second, third, fourth, and fifth harmonic generation) or parametric sum frequency generation to create light in the far-UVC. Such systems may likewise be large (e.g., table-top size or macroscopic optical bench size), expensive, and inefficient (e.g., generating less than a watt optical in the far UVC). Free-electron pumped field emission lamps with hexagonal Boron Nitride (h-BN) target may rely on bulbs that are vacuum sealed to allow the electron beam to operate, but the power efficiency and reliability of such lamps may be unproven.

Semiconductor-based light emitting diode (LED) and laser diode (LD) light sources (e.g., based on GaN material system) have also been used to provide UVC light, for example, LED light sources using phosphor-based wavelength conversion. However, far-UVC LEDs and LDs may currently suffer from poor efficiency, low output power, and short lifetime due to fundamental limits of the material properties, as well as poor performance at emission wavelengths shorter than about 265 nm. Also, due to residual uncertainty about human safety, regulatory limits remain strict.

### SUMMARY

According to some embodiments, a photonic integrated circuit (PIC) comprises a substrate, a light emitting element comprising a first material on the substrate, and an optical structure comprising a second material on the substrate. The light emitting element is configured to generate light of a first frequency or wavelength range. The optical structure is optically coupled to the light emitting element to receive the light of the first frequency or wavelength range therefrom and comprises a nonlinear optical element that is configured to generate UVC light of a second frequency or wavelength range. The optical structure further comprises at least one of: a transition element that is tapered between a first width adjacent to the light emitting element and a second width distal from the light emitting element; and a polarization management element that is configured to alter a first polarization of the light received from the light emitting element to a second polarization.

In some embodiments, the second material is native to the substrate, and the first material is non-native to the substrate.

In some embodiments, a portion of the transition element extends between the light emitting element and the substrate.

In some embodiments, the portion of the transition element further comprises a third material that is stacked between the first material of the light emitting element and the second material, the third material having a refractive index that is between respective refractive indices of the first material and the second material.

In some embodiments, the polarization management element comprises a first stage comprising a first waveguide segment configured to alter the first polarization to an intermediate polarization, and a second stage comprising a second waveguide segment configured to alter the intermediate polarization to the second polarization.

In some embodiments, the first stage comprises a first portion of the first waveguide segment that is tapered with increasing width toward the second stage, and the second stage comprises a directional coupler in which the second waveguide segment extends along a second portion of the first waveguide segment.

In some embodiments, the first polarization is transverse electric (TE), and the second polarization is transverse magnetic (TM).

In some embodiments, the first material comprises a group-III nitride, and the second material comprises aluminum nitride.

According to some embodiments, a photonic integrated circuit (PIC) comprises a substrate, a light emitting element on the substrate, a polarization management element on the substrate, and a nonlinear optical element on the substrate. The light emitting element is configured to generate light of a first frequency or wavelength range. The polarization management element is configured to alter a polarization of the light of the first frequency or wavelength range from a first polarization to a second polarization. The nonlinear optical element is configured to receive the light of the first frequency or wavelength range and the second polarization and generate UVC light of a second frequency or wavelength range and the second polarization.

In some embodiments, the light emitting element comprises a first material, and at least one of the polarization management element and the nonlinear optical element comprises a second material that is different than the first material.

In some embodiments, the second material is native to the substrate, and the first material is non-native to the substrate.

In some embodiments, the PIC further comprises at least one waveguide element comprising the second material on the substrate. The at least one waveguide element is optically coupled between the light emitting element and the nonlinear optical element.

In some embodiments, the light emitting element comprises a gain element including at least one quantum well of the first material, and the PIC further comprises a transition element comprising the second material on the substrate and optically coupled between the gain element and the at least one waveguide element. The transition element is tapered between a first width adjacent to the gain element and a second width adjacent to the at least one waveguide element.

In some embodiments, a portion of the transition element extends between the light emitting element and the substrate.

In some embodiments, the portion of the transition element further comprises a third material having a refractive index that is between respective refractive indices of the first material and the second material.

In some embodiments, the PIC further comprises a phase tuning structure comprising the second material and at least one microheater element on the substrate and optically coupled to the gain element.

In some embodiments, the polarization management element is a polarization rotator comprising the second material and optically coupled between the light emitting element and the nonlinear optical element.

In some embodiments, the polarization rotator comprises a first stage comprising a first waveguide segment and configured to alter the first polarization to an intermediate polarization, and a second stage comprising a second waveguide segment and configured to alter the intermediate polarization to the second polarization.

In some embodiments, the first stage comprises a first portion of the first waveguide segment that is tapered with increasing width toward the second stage, and the second stage comprises a directional coupler in which the second waveguide segment extends along a second portion of the first waveguide segment.

In some embodiments, the first polarization is transverse electric (TE), the second polarization is transverse magnetic (TM), and at least one of the first waveguide segment and the second waveguide segment comprises a non-vertical sidewall angle.

In some embodiments, the second material comprises single-crystal aluminum nitride, and the substrate comprises sapphire.

According to some embodiments, a photonic integrated circuit (PIC) comprises a substrate, a light emitting element comprising a first material on the substrate, a nonlinear optical element comprising a second material on the substrate, and a transition element comprising the second material on the substrate. The light emitting element is configured to generate light of a first frequency or wavelength range. The nonlinear optical element is configured to receive the light of the first frequency and generate UVC light of a second frequency or wavelength range. The transition element is tapered between a first width adjacent to the light emitting element and a second width distal from the light emitting element.

In some embodiments, the second material is native to the substrate, and the first material is non-native to the substrate.

In some embodiments, a portion of the transition element extends between the light emitting element and the substrate.

In some embodiments, the portion of the transition element further comprises a third material that is stacked between the first material of the light emitting element and the second material, the third material having a refractive index that is between respective refractive indices of the first material and the second material.

In some embodiments, the PIC further comprises a polarization management element comprising the second material on the substrate and optically coupled between the transition element and the nonlinear optical element. The polarization management element is configured to alter a polarization of the light of the first frequency or wavelength range from a first polarization to a second polarization.

In some embodiments, the first material comprises a group-III nitride, the second material comprises aluminum nitride, and the substrate comprises sapphire.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a schematic block diagram illustrating an example of a photonic integrated circuit (PIC) according to some embodiments of the present disclosure.

FIG. 2A is a schematic plan view illustrating an example of a PIC according to some embodiments of the present disclosure in greater detail.

FIG. 2B is a schematic cross-sectional view of the gain element or gain structure of the light emitting element of FIG. 2A.

FIG. 2C is a schematic cross-sectional view of a phase shifter or phase tuning structure of the light emitting element of FIG. 2A.

FIG. 2D is a schematic cross-sectional view of a waveguide structure of FIG. 2A.

FIG. 3A is a schematic cross-sectional view illustrating an example deep-etched gain element on an optical waveguide structure according to some embodiments of the present disclosure in greater detail.

FIG. 3B a schematic cross-sectional view illustrating an example shallow-etched gain element on an optical waveguide structure according to some embodiments of the present disclosure in greater detail.

FIG. 3C is a schematic cross-sectional view illustrating an example deep-etched gain element on an optical waveguide structure with an electrically conductive transparent layer therebetween according to further embodiments of the present disclosure in greater detail.

FIG. 3D a schematic cross-sectional view illustrating an example shallow-etched gain element on an optical waveguide structure with an electrically conductive transparent layer therebetween according to further embodiments of the present disclosure in greater detail.

FIG. 4A is a schematic plan view and FIGS. 4B, 4C, 4D, 4E, 4F, 4G, 4H, and 4I are schematic cross-sectional views of respective portions of a transition region or transition element between the gain element and the optical waveguide structure in a PIC according to some embodiments of the present disclosure, which may correspond to the deep-etched gain waveguide structure of FIGS. 3A and 3C.

FIG. 5A is a schematic plan view and FIGS. 5B, 5C, 5D, 5E, 5F, 5G, 5H, 5I, and 5J are schematic cross-sectional views of respective portions of a transition region or transition element between the gain element and the optical waveguide structure in a PIC according to some embodiments of the present disclosure, which may correspond to the shallow-etched gain waveguide structure of FIGS. 3B and 3D.

FIG. 6A is a schematic plan view and FIG. 6B is a schematic cross-sectional view of respective portions of a polarization management element in a PIC according to some embodiments of the present disclosure.

### DETAILED DESCRIPTION OF EMBODIMENTS

As noted, far-UVC light (including wavelengths of about 200 nm to about 240 nm, e.g., 200 nm to 230 nm) has become an emerging technology for human-safe disinfection because of its high germicidal efficacy against airborne pathogens with potentially no harm to human health. Far-UVC light may also have potential for many other applications, including sensing, agriculture, and spectroscopy.

Nonlinear frequency conversion provides one approach to realizing far-UVC light sources. For example, the generation of far-UVC light has been demonstrated by second harmonic generation (SHG) in bulk nonlinear crystals like beta barium borate (BBO) with blue pump light. However, such systems (as described for example in “Compact deep UV system at 222.5 nm based on frequency doubling of GaN laser diode emission” to Ruhnke et al., IEEE Photon. Technol. Lett. 30, 289 (2018)) may require complex bulk optical components, and typically exhibit low coupling and generation efficiency.

Photonic waveguide-based frequency doublers have attracted interest for far-UVC light sources due to reduced size and operation power, increased efficiency, and flexible phase matching techniques. For example, far-UVC SHG has been demonstrated across a bonded interface using a silicon nitride waveguide and a BBO crystal via Cherenkov phase-matching, as described for example in “Continuous-wave second-harmonic generation in the far-UVC pumped by a blue laser diode” to E. J. Stanton et al., Sci. Rep. 14, 3238 (2024). In this approach, since SHG occurs at a walk-off Cherenkov angle relative to the passing pump beam along the waveguide, the generated far-UVC light may propagate off-plane or out-of-plane without good optical confinement, which may make on-chip control challenging.

Another approach is based on SHG in AlN-based waveguides via transverse quasi-phase-matching (QPM) (as described for example in “UV second harmonic generation in AlN waveguides with modal phase matching” to T. Troha et al., Opt. Mater. Express 6, 2014 (2016)), in which the generated far-UVC light co-propagates with the pump light along the waveguides. The SHG-based far-UVC light sources have typically relied on separate lasers to deliver sufficient optical pump power, but may have poor coupling efficiency and alignment tolerance when the pump light is coupled into the SHG waveguide due to significant mode mismatch, resulting in increased packaging costs and limited scalability.

Embodiments of the present disclosure are directed to generation of light in the far-UVC band using compact sources based on materials and processes from the semiconductor industry, which allows rapid volume scaling reduction of cost that may not be available by other methods. Embodiments of the present disclosure may provide a UVC (and in some embodiments, far-UVC) light source including a semiconductor light emitting element (such as a pump laser (e.g., a Group-III nitride-based laser diode) or other Group III-V-based light emitting element) configured to generate light of a first wavelength (e.g., in the visible spectrum, also referred to herein as visible light), which is coupled into a nonlinear optical (NLO) element (e.g., an integrated waveguide with nonlinear optical properties) for generation of light that is a sum of the frequency of the visible light (also referred to herein as sum frequency generation (SFG), e.g., Second Harmonic Generation (SHG) or frequency doubled light). Sum frequency generation may include both frequency doubling (combination of photons of the same wavelength) and optical parametric conversion (i.e., from combination or difference of two photons of unequal wavelength). The nonlinear optical element may be referred to herein as an SHG element, or more generally, an SFG element. The sum frequency generation or frequency-doubling converts a portion of the visible light emitted by the light emitting element into far-UVC light. The term wavelength converter element (or simply “wavelength converter”) may be used herein to generally refer to nonlinear optical elements, SFG elements, and SHG elements.

Second (or third, fourth, etc.) harmonic frequency generation using nonlinear optical materials in accordance with some embodiments may require several components or characteristics for efficient conversion. For example, a nonlinear crystal that is non-centrosymmetric and highly polarizable may lead to non-zero elements of its second order non-linearity tensor, where the higher this coefficient, the higher the conversion rate. The nonlinear crystal should be partially optically transparent at the wavelength of the frequency doubled light; otherwise the crystal would absorb the newly generated light. Also a pump light source that is coherent (second harmonic generation is a coherent effect relevant to a single wavelength, so the pump laser may have a narrow linewidth with sufficiently long coherence length) and high power (the output power of second harmonic generation scales with the square of the pump power; therefore the higher the power of the pump laser the higher the efficiency of conversion) may be used. In some embodiments, pulsed lasers, which generally have higher peak pulse power than continuous wave (CW) lasers, may be used. In some embodiments, on-chip phase matching may be used to match the phase of the pump wavelength to that of the SHG element, e.g., such that coherent addition of the electric field from both waves is maintained over some or all of the propagation length of the nonlinear crystal as may improve efficiency. Embodiments of the present disclosure may include aspects of UV light sources as described in PCT Application No. PCT/US2023/013187 entitled NONLINEAR SOLID STATE DEVICES FOR OPTICAL RADIATION IN FAR-UVC SPECTRUM, filed February 16, 2023, the disclosure of which is incorporated by reference herein.

Some structures may involve homogeneous and/or heterogeneous integration into a single chip or block of semiconductor material. Homogeneous integration may refer to the fabrication of a single photonic integrated circuit chip using semiconductor materials that are grown onto a single native (e.g., growth) substrate in one or more growth steps to form a photonic integrated circuit, including two or more active (e.g., light emitting) and passive (e.g., waveguides, nonlinear/wavelength converting optical elements, or other optical coupling elements) devices.

Heterogeneous integration may join two or more dissimilar semiconductor optical materials or structures, which are subsequently processed to form a single photonic integrated circuit chip including active and passive devices coupled to one another on a native or non-native substrate. The dissimilar materials may be formed by epitaxial growth on separate substrates and subsequently joined together using micro-transfer printing, wafer bonding, flip chip bonding, die-to-wafer joining, direct bonding, or other forms of mass transfer for integration.

Solid state (or monolithic) integration may refer to any arrangement of active and/or passive elements in a unitary structure, without air interfaces or free propagation of light between elements longer than 5-10x the wavelength. Solid state integration may thus include elements of the same (homogeneous) material system or multiple (heterogeneous) materials, and may be provided on a native substrate or on a non-native substrate (which is different from the native or source substrate on which the elements are grown or otherwise formed).

Structures as described herein may also be used in hybrid integration, which may refer to arrangement of separate or discrete functional elements (e.g., respective light emitting and wavelength converting semiconductor elements) on a non-native substrate (i.e., a substrate that is different from the native or source substrate on which the elements are grown or otherwise formed). Hybrid integration may generally be performed at the packaging stage, after the fabrication of the PIC and photonic device chips. That is, hybrid integration may join two or more individual completed and tested photonic chips, each independent of each other, onto a substrate or platform as part of a photonic packaging process (for example, by attaching discrete photodetectors, lasers, and modulators together in an optical train to form a hybrid photonic circuit within an optoelectronic package).

Some embodiments of the present disclosure provide far-UVC photonic integrated circuits (PIC) (for example, based upon the III-nitride material system, such as AlN/AlScN/GaN/InGaN/GaAlN-based devices), with up to all of the associated photonic components integrated on a common optical structure, also referred to herein as a heterogeneous integration platform (which in some embodiments may include a substrate and at least one component that is native to the substrate, with additional components fabricated or otherwise integrated thereon) so as to achieve compact solid-state far-UVC light sources.

Some embodiments may arise from realization that some nonlinear optical materials (such as AlN-based materials, including AlN, AlGaN, and AlScN) may have a crystalline structure in which the c axis may be aligned perpendicular to the wafer substrate, which can lead to larger values of second-order nonlinear coefficients for transverse magnetic (TM) modes as compared to the transverse electric (TE) modes. However, the output beam of semiconductor lasers is typically primarily TE mode. PICs according to embodiments of the present disclosure may therefore integrate a low-loss (e.g., AlN-based) polarization management element to efficiently convert the TE output mode of the on-chip laser (generally referred to herein as a light emitting element) into TM mode as an optical pump for the nonlinear optical element, providing higher efficiency second harmonic generation of far-UVC light.

Some embodiments may further recognize that there may be a non-trivial difference of refractive index n between the material of the active light emitting element (e.g., InGaN/GaN, having n~2.6) and the material of the passive nonlinear optical element or waveguide (e.g., AlN, having n~2.1), which may present challenges with optical coupling efficiency. PICs according to embodiments of the present disclosure may thus further include a transition element including one or more layers (e.g., one or more dielectric material layers, such as titanium oxide (TiO₂)) having a refractive index that is between the respective refractive indices of the light emitting element material (e.g., InGaN, GaN, or other group III-nitrides) and the nonlinear optical material (e.g., AlN, AlGaN, AlScN) to achieve higher optical coupling efficiency. The transition element may be implemented as a multi-stage adiabatic taper, to provide a low-loss interface between the group III-nitride (or other semiconductor) active gain region and low loss AlN (or other nonlinear element) passive waveguides. The coupling between active and passive elements may be in-plane (i.e., where the coupled passive elements are substantially aligned with the direction or plane of light propagation as output from the active elements) or evanescent (i.e., where the coupled elements are offset from the direction or plane of light propagation as output from the active elements, for example, with directional coupling elements therebetween, such that that the evanescent field generated by one element excites the other).

That is, PICs as described herein include various photonic components across multiple materials (such as, but not limited to, III-nitrides, metallic oxides, silicon dioxide) through heterogeneous integration, where multiple functionalities (such as gain, modulation, filtering, polarization management, and/or nonlinear frequency conversion) are integrated on a single photonic chip or block of semiconductor material. For example, providing Group III-nitride materials on single-crystal AlN-based heterogeneous integration platform (more generally referred to as a multifunctional optical structure or optical waveguide structure) can implement a PIC combining different materials that are configured or optimized for specific functions so as to efficiently generate far-UVC light.

In particular embodiments, in the PIC, blue pump light is generated and polarization-tailored to efficiently generate far UVC light by second harmonic generation (SHG). However, embodiments of the present disclosure may include any configuration of a semiconductor light emitting element (such as a pump laser) configured to generate light of a first wavelength, which is coupled into an optical structure including a nonlinear optical (NLO) element configured to generate of light of a second wavelength that is a sum of the frequency of the light of the first wavelength, which (along with other elements, such as a polarization rotator and/or an output coupler) are integrated on the same chip; where blue light, UVC light, and second harmonic generation (SHG) are described as non-limiting examples of the first wavelength, the second wavelength, and the sum frequency generation (SFG), respectively.

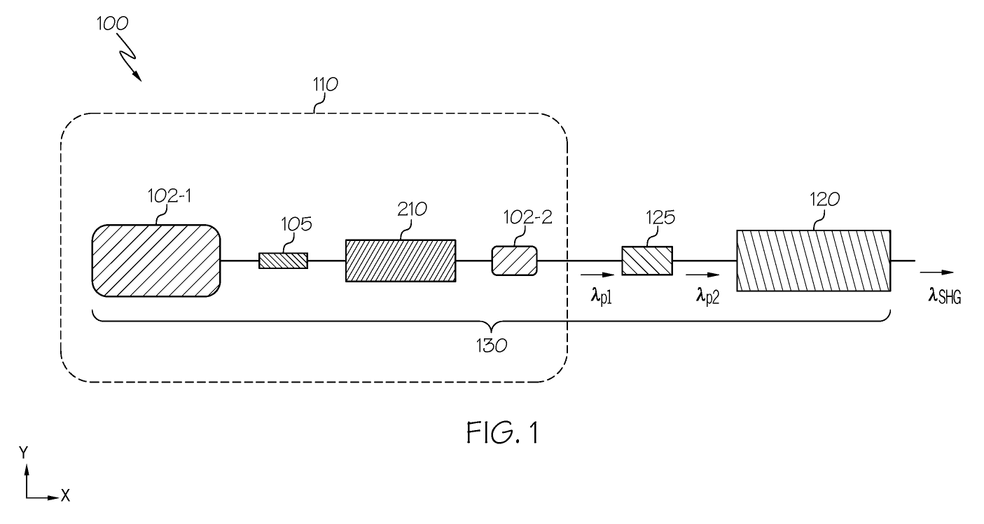

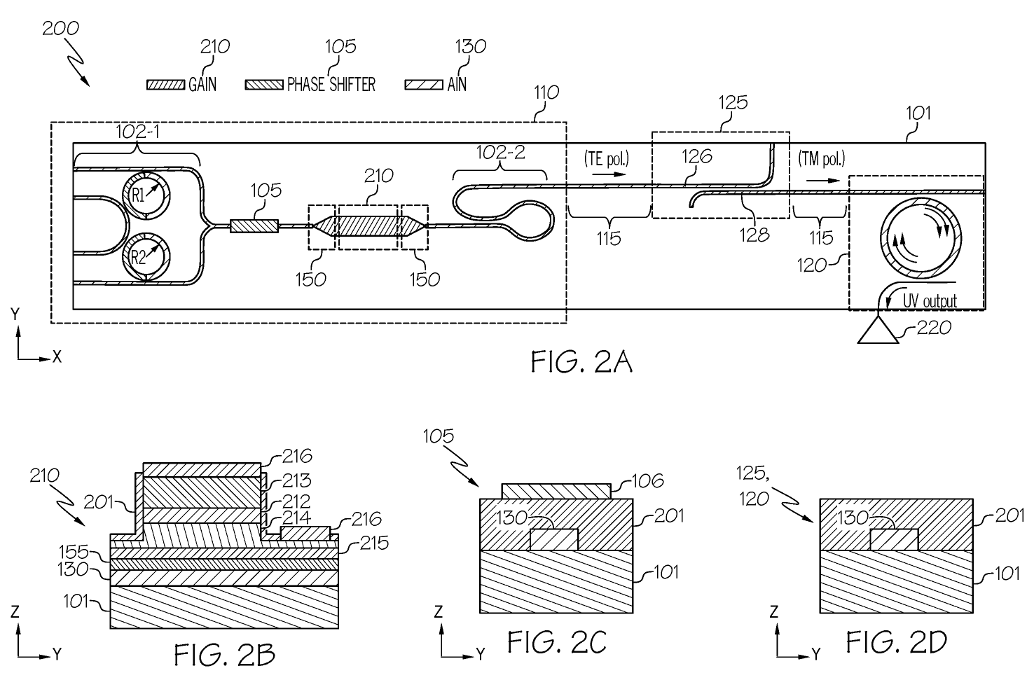

FIG. 1 is a block diagram illustrating an example of a PIC 100 according to some embodiments of the present disclosure. The PIC 100 includes at least a light emitting element 110 (e.g., pump laser), a polarization management element 125 (e.g., polarization rotator, such as a polarization splitter rotator), and a nonlinear optical element 120 (e.g., frequency doubler), which are integrated in a solid-state structure (e.g., a substrate 101, see FIG. 2A).

As shown in FIG. 1, the pump laser 110 includes a gain element 210 and optical mirrors 102-1, 102-2 that form a laser cavity. The optical mirrors 102-1, 102-2 can be implemented in multiple ways, including (but not limited to) waveguide gratings, waveguide loop mirrors, and/or ring resonators. Phase tuning elements 105 (which may be thermo-optic and/or electro-optic based; also referred to as phase shifters) can be included to achieve wavelength tuning. The frequency doubler (or other sum frequency generator element) can be realized by nonlinear optical waveguides and/or cavities (e.g., ring resonators) that are configured to fulfill phase matching requirements for nonlinear frequency conversion (e.g., second harmonic generation), and may generally be referred to herein as a nonlinear optical element 120. Various approaches for phase matching such as periodic poling, quasi-phase matching, and inter-modal phase matching can be implemented to efficiently generate far-UVC light. A polarization management element 125 (e.g., polarization rotator or polarization splitter rotator) may be included in the solid-state structure to provide desired or optimal pump polarization for high-efficiency nonlinear frequency conversion.

FIGS. 2A to 2D illustrate a PIC 200 according to some embodiments of the present disclosure in greater detail. In particular, FIG. 2A is a plan view schematic diagram illustrating the PIC 200; FIG. 2B is a cross-sectional view of the gain element or gain structure 210 of the (e.g., blue light-emitting) pump laser 110 of FIGS. 2A; 2C is a cross-sectional view of the phase shifter or phase tuning structure 105 of the pump laser 110 of FIGS. 2A; and 2D is a cross-sectional view of the underlying optical structures 130/101 of FIG. 2A (portions of which may be used to implement the passive waveguide structures 115, the polarization management element 125, and/or SHG element 120 described herein). As shown in the example of FIG. 2A, group III-nitride materials 210 are provided on single-crystal AlN on sapphire-based heterogeneous integration platform, which provides a multifunctional optical structure 130/101 to realize a solid-state PIC 200 for far-UVC light sources. The materials illustrated herein (e.g., SiO₂, TiO₂, AlN, sapphire) are shown by way of example only, and it will be understood that embodiments of the present disclosure are in no way limited to implementation using these example materials. For example, the heterogeneous integration platform 130/101 may include other nonlinear materials (e.g., AlGaN, AlScN) and/or insulating substrates.

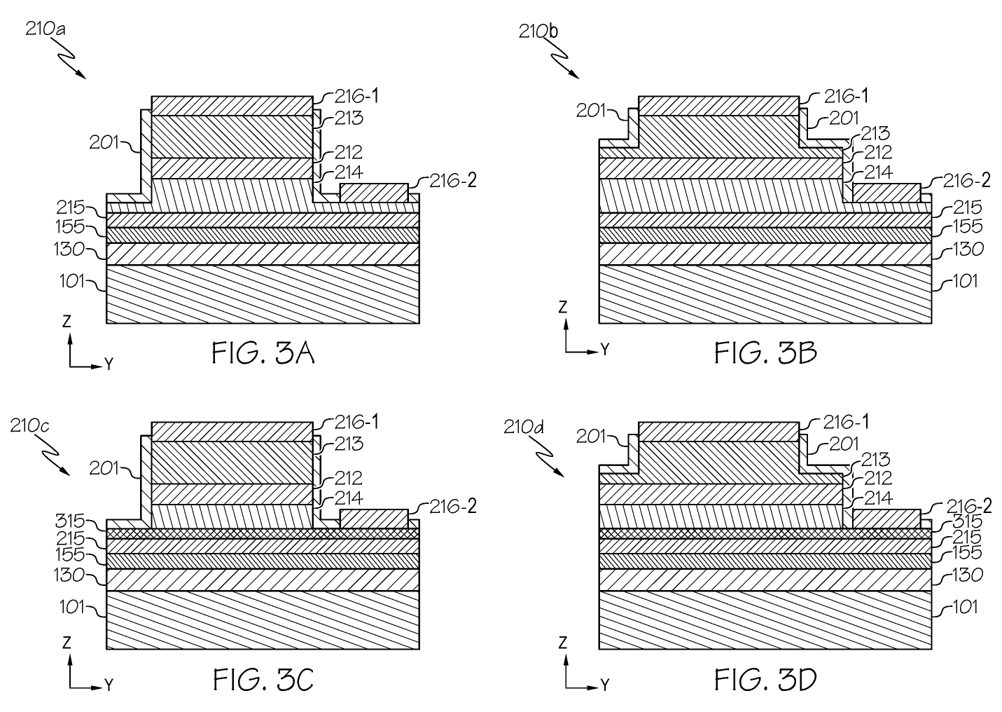

As shown in FIG. 2B, for the pump laser 110, the active gain element 210 is implemented by group III-nitride (e.g., In/Ga/Al/N) materials that provide at least one quantum well (QW) active region 212 (see FIGS. 3A-3D) configured for light emission at a first wavelength λ1 in the blue portion of the visible spectrum, e.g., at about 450 nm. Other passive components in this example (e.g., mirrors 102-1, 102-2, polarization rotator 125, frequency doubler 120) are implemented by nonlinear (e.g., single-crystal AlN strip) waveguides, which may be provided by portions of the underlying optical structure 130/101. One mirror 102-1 of the pump laser is implemented by a Vernier-ring configuration with phase shifters, which can provide wide wavelength tunability. Another mirror 102-2 is implemented by a waveguide loop mirror. As shown in FIG. 2C, the phase shifter/phase tuning structure 105 is implemented by providing one or more microheater elements 106 on the AlN-based optical structure 130/101.

In the example of FIG. 2B, the group III-nitride-based active gain element 210 is bonded to the AlN-based optical structure 130/101. For example, a form of dielectric-based hybrid bonding can be used to create a low-loss bonding interface between the overlying group III nitride-based gain element 210 and the underlying -based optical structure 130/101. An auxiliary layer 155 (e.g., a TiO₂ layer in this example) may be provided between the overlying group III nitride-based gain element 210 and the underlying -based optical structure 130/101. In the transition region 150 between the gain element 210 and the waveguide elements (e.g., 115), a high-efficiency multi-stage adiabatic taper is used to couple the optical mode from the gain region 210 to the AlN-based optical structure 130/101.

In the example of FIG. 2D, a polarization management element 125 (e.g., a polarization splitter rotator) is implemented by a two-stage AlN adiabatic taper structure to convert the TE (transverse electric) mode polarized light (also referred to as a first polarization or first polarization orientation) that is output from the pump laser to TM (transverse magnetic) mode polarized light (also referred to as a second polarization or second polarization orientation) for input to (efficiently pump) the second harmonic generation (SHG) element 120, also referred to as a frequency doubler. In the example of FIGS. 2A-2D, the frequency doubler 120 is implemented by a high-Q AlN ring resonator, which is configured to provide intermodal phase matching for SHG. The converted TM pump light output from the polarization splitter rotator 125 is coupled into the ring resonator of the frequency doubler 120 through an input bus waveguide 115, the ring resonator of the frequency doubler 120 responsively generates far-UVC light, and the generated far-UVC light is coupled out through an output bus waveguide 115. An on-chip output coupler 220 may be provided at the output port of the output bus waveguide 115 to further shape the output beam of the far-UVC light as needed or desired.

More generally, as shown in FIGS. 1 and 2, a PIC 100, 200 includes a light emitting element 110 of a first material (e.g., a group III nitride material), and an optical structure 130/101 of a second material (e.g., an AlN-based material) on a substrate (e.g., a sapphire substrate). The light emitting element 110 is configured to generate light of a first frequency or wavelength range. The optical structure 130/101 is optically coupled to the light emitting element 110 to receive the light of the first frequency or wavelength range therefrom, and includes a nonlinear optical element 120 that is configured to generate far UVC light of a second frequency or wavelength range. The optical structure 130/101 further includes a transition element 150 that is tapered between a first width adjacent to the light emitting element 110 and a second width distal from the light emitting element 110, and/or a polarization management element 125 that is configured to alter a first polarization of the light received from the light emitting element 110 to a second polarization. The PIC 100, 200 may further include a phase tuning structure 105 of the second material that is optically coupled to the gain structure 210 and includes at least one microheater element 106 thereon. The PIC 100, 200 may also include at least one waveguide element 115 of the second material that is optically coupled between the light emitting element 110 and the nonlinear optical element 120. The materials of the optical structure 130 (including the nonlinear optical element 120, the transition element 150, the polarization management element 125, the waveguide element(s) 115, and/or the phase tuning structure 105) and the light emitting element 110 may differ. For example, the material of the optical structure 130 may be native to the substrate 101, while the material of the light emitting element 110 may be non-native to the substrate 101.

FIGS. 3A-3D illustrate examples of gain elements 210 on optical structures 130/101 (e.g., as shown in FIG. 2B above) in greater detail. In particular, FIGS. 3A and 3C are cross-sectional views illustrating deep-etched gain elements 210a and 210c on an optical waveguide structure 130/101 in which the QW active region 212 (which may include one or multiple quantum well layers) is substantially etched, e.g., etched completely through the QW active region 212. FIGS. 3B and 3D are cross-sectional views illustrating shallow-etched gain elements 210b, 210d on optical structures 130/101 in which the overlying group III nitride upper cladding layer 213 is etched, but the QW active region 212 and the underlying group III nitride lower cladding layer 212 are not etched.

As shown in FIGS. 3A-3D, a top contact 216-1 is provided on the overlying (e.g., n-type) group III-nitride layer(s) 213 of the gain element 210, opposite the optical structure 130/101 (which in this example is implemented by AlN on a sapphire substrate). A bottom contact 216-2 is provided directly on the underlying (e.g., p-type) group III-nitride layer(s) 214 in FIGS. 3A and 3B, while the bottom contact 216-2 is provided directly on an additional electrically-conductive transparent layer (ECTL) 315 in FIGS. 3C and 3D. The ECTL 315 (e.g., indium tin oxide (ITO)) can be used to provide a conductive contact layer with the (e.g., p-type) group III-nitride lower cladding layer 214. Insulating layers 201 (e.g., SiO2) may be provided on one or more or sidewalls of the gain elements 210.

A dielectric bonding layer 215 (e.g., SiO₂, Al₂O₃, etc.) is used for bonding the group III-nitride-based gain element 210 to the optical waveguide structure 130/101 provided by the AlN on sapphire substrate. One or more auxiliary layers 155 may extend between the gain element 210 and the optical waveguide structure 130/101. The auxiliary layer(s) 155 may be implemented by a material (e.g., a dielectric material or metal oxide material, such as TiO₂, SixNy, SiOxNy) having a refractive index between the respective refractive indices of the group III-nitride materials of the gain element 210 and the AlN-based layer 130 optical structure 130/101. The auxiliary layer(s) 155 may be included in or may be a portion of a transition element or region 150 that extends between the gain element 210 and the substrate 101 (see FIG. 2A), e.g., for multi-stage adiabatic taper configurations.

More generally, as shown in FIGS. 3A-3D, a light emitting element 110 includes a gain structure 210 having at least one quantum well layer 212 of a first material (e.g., a group III-nitride). A transition element 150 of a second material (e.g., an AlN-based material) may be optically coupled between the gain structure 210 and at least one waveguide element 115 of the optical structure 130/101. The transition element 150 may include an auxiliary layer 155 of a third material (e.g., a dielectric or metal oxide material) having a refractive index that is between the respective refractive indices of the first material and the second material.

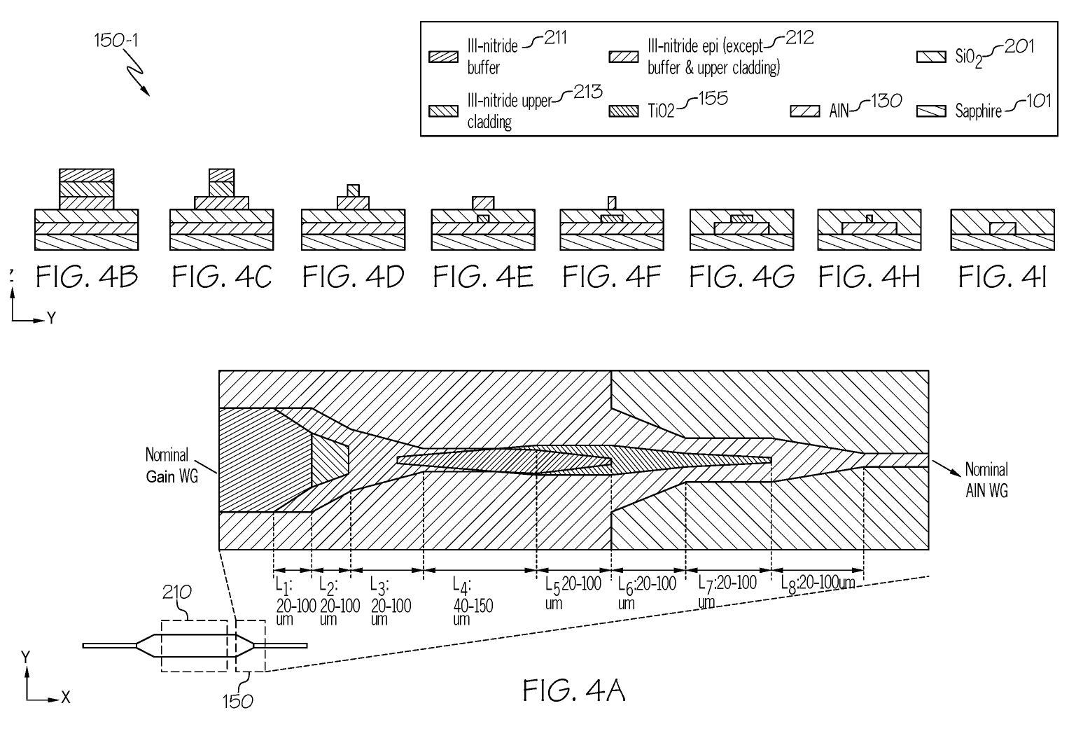

FIG. 4A is a schematic top or plan view and FIGS. 4B, 4C, 4D, 4E, 4F, 4G, 4H, and 4I are schematic cross-sectional views of respective portions of a transition region or transition element 150-1 between the gain element 210 and the optical waveguide structure 130/101 in a PIC according to some embodiments of the present disclosure. The embodiments of FIGS. 4A-4I may correspond to the deep-etched gain waveguide structures 210a and 210c of FIGS. 3A and 3C.

As shown in FIGS. 4A-4I, the transition element 150-1 is implemented as or includes a multi-stage adiabatic taper region. A group III nitride buffer layer 211, upper cladding layer 213, and epi/QW layer 212 of the gain structure 210 may have substantially uniform widths (in plan view, along a horizontal or Y-direction) in the gain region 210, but may have respective widths in the transition region 150-1 that are tapered (in plan view) with distance (in a horizontal or X-direction) from the gain region 210 (e.g., from the uniform widths adjacent the gain region 210 down to substantially narrower widths distal from the gain region 210). The widths of the group III nitride buffer layer 211, cladding layer 213, and epi/QW layer(s) 212 (along the Y-direction in FIGS. 4A-4I) may be tapered over portions of the underlying AlN-based optical structure 130/101 having a uniform width (along the Y-direction in plan view).

In the example of FIGS. 4A-4I, the auxiliary layer 155 (e.g., TiO₂) may be provided (e.g., stacked, in the vertical or Z-direction) between the epi/QW layer 212 of the gain element 210 and the underlying AlN structure 130, for example, beginning at a distal portion of the epi/QW layer 212 (e.g., when the overlying upper cladding layer 213 has tapered to a minimum width in plan view) and extending in a direction away from the gain region 210 (shown along a horizontal or X-direction). The auxiliary layer 155 and the underlying AlN structure 130 may each be likewise tapered from the distal portion of the epi layer 212 in a direction away from the gain region 210 (along the X-direction), so as to provide coupling of the optical mode from the gain region 210 to the AlN structure 130.

In greater detail, the buffer layer 211 and upper cladding layer 213 are tapered adiabatically over lengths L₁ and L₂, respectively, in the first two sections or stages (shown in FIGS. 4C-4D) of the transition region 150-1 (with the tapered stages and corresponding lengths L₁-L₈ shown from left to right in the plan view of FIG. 4A, illustrating regions between each of the cross-sectional views of FIGS. 4B-4I) to push the optical mode in the nominal gain waveguide region (shown at far left of FIG. 4A) into the lower epi/QW layers 212. The epi/QW layers 212 continue to be tapered (as shown in FIGS. 4C and 4D), and the tapered auxiliary layer 155 (e.g., TiO₂) extends thereunder (as shown in FIGS. 4E and 4F) so that the optical mode transition occurs from the epi/QW layers 212 to the auxiliary layer 155 through evanescent-wave coupling. The auxiliary layer 155 waveguide is further tapered (as shown in FIGS. 4G and 4H) to couple the optical mode into the AlN structure 130 thereunder. The width of the AlN waveguide may be further tapered adiabatically (as shown in FIGS. 4H and 4I) to the nominal width (shown at far right of FIG. 4A) if needed or desired. The transition element 150-1 further includes a dielectric or insulating layer 201 (e.g., SiO₂) on one or more regions thereof.

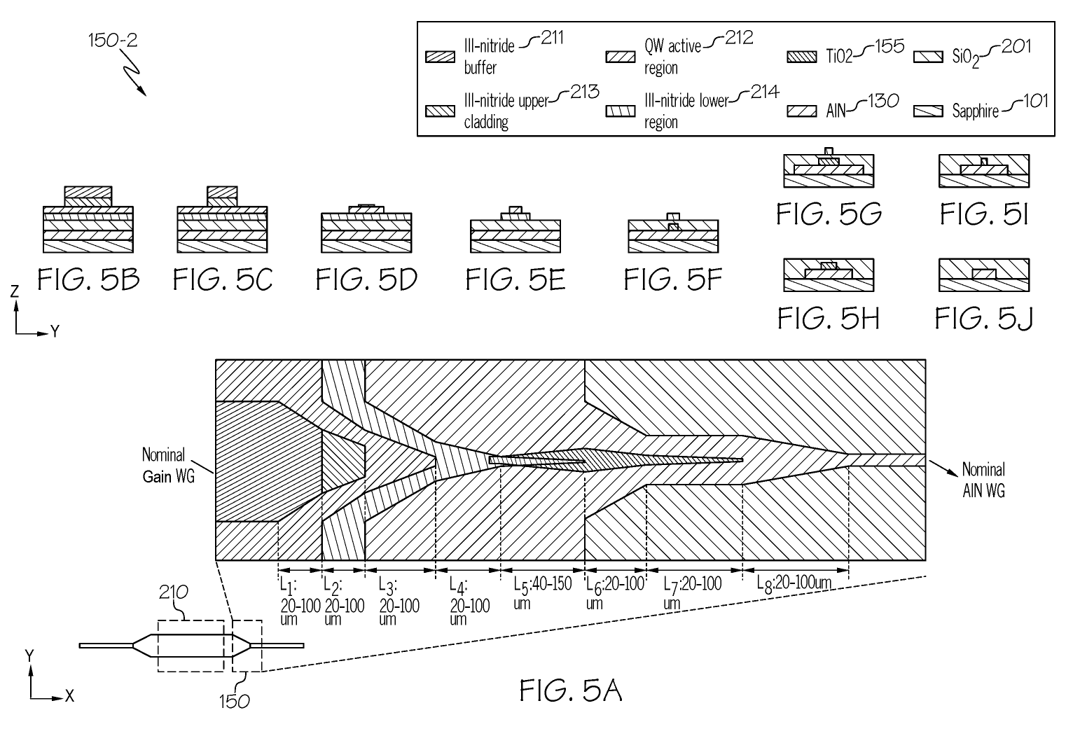

FIG. 5A is a schematic top or plan view and FIGS. 5B, 5C, 5D, 5E, 5F, 5G, 5H, 5I, and 5J are schematic cross-sectional views of respective portions of a transition region or transition element 150-2 between the gain element 210 and the optical waveguide structure 130/101 in a PIC according to some embodiments of the present disclosure. The embodiments of FIGS. 5A-5J may correspond to the shallow-etched gain waveguide structures 210b and 210d of FIGS. 3B and 3D.

As shown in FIGS. 5A-5J, the transition element 150-2 is likewise implemented as or includes a multi-stage adiabatic taper region. The group III nitride buffer layer 211 and upper cladding layer 213 may have substantially uniform widths (in plan view, along a horizontal or Y-direction) in the gain region 210. The QW layer(s) 212 and lower cladding region 214 may likewise have substantially uniform plan view widths in the gain region (which are greater than the widths of the buffer layer 211 and the upper cladding layer 213). The group III nitride buffer layer 211, upper cladding layer 213, QW layer(s) 212, and lower cladding layer 214 may have respective widths in the transition region 150-2 that are tapered (in plan view) with distance (shown in a horizontal or X-direction) from the gain region 210 (e.g., from the uniform widths adjacent the gain region 210 down to substantially narrower widths distal from the gain region 210, in the X-direction). The widths of the group III nitride buffer layer 211, upper cladding layer 213, QW layer(s) 212, and lower cladding layer 214 (along the Y-direction) may be tapered over portions of the underlying AlN-based optical structure 130/101 having a uniform width (in plan view).

In the example of FIGS. 5A-5J, the auxiliary layer 155 (e.g., TiO₂) may be provided (e.g., stacked, in the vertical or Z-direction) between the group III nitride lower cladding layer 214 of the gain element 210 and the underlying AlN structure 130, for example, beginning at a distal portion of the lower cladding layer 214 (e.g., when the overlying QW layer 212 has tapered to a minimum width in plan view) and extending in a direction away from the gain region 210 (shown as along the X-direction). The auxiliary layer 155 and the underlying AlN structure 130 may each be likewise tapered from the distal portion of group III nitride lower region 214 in a direction away from the gain region 210 (along the X-direction), so as to provide coupling of the optical mode from the gain region 210 to the AlN structure 130.

In greater detail, the buffer layer 211, upper cladding layer 213, and QW layer(s) 212 are tapered adiabatically over lengths L₁, L₂, and L₃, respectively, in the first three sections or stages of the transition region 150-2 (with the tapered stages and corresponding lengths L₁-L₈ shown from left to right in the plan view of FIG. 5A, illustrating regions between each of the cross-sectional views of FIGS. 5B-5J) to push the optical mode in the nominal gain waveguide region (shown at far left of FIG. 5A) into the lower epi layers 212, 214. The lower epi layers 212, 214 continue to be tapered (as shown in FIGS. 5D and 5E), and the tapered auxiliary layer 155 (e.g., TiO₂) extends thereunder (as shown in FIGS. 5F and 5G) so that the optical mode transition occurs from the lower epi layers 212, 214 to the auxiliary layer 155 through evanescent-wave coupling. The auxiliary layer 155 waveguide (as shown in FIGS. 5H and 5I) is further tapered to couple the optical mode into the AlN structure 130 thereunder. The width of the AlN structure 130 may be further tapered adiabatically (as shown in FIGS. 5I and 5J) to the nominal width (shown at far right of FIG. 5A) if needed or desired. The transition element 150-2 further includes a dielectric or insulating layer 201 (e.g., SiO₂) on one or more regions thereof.

More generally, as shown in FIGS. 4A-5J, a transition element 150 of a second material (e.g., an AlN-based material) may be coupled between a light emitting element 110 of a first material (e.g., a group III nitride material) and a nonlinear optical element 120 of the second material. The second material may be native to the substrate 101, while the first material may be non-native to the substrate 101. The transition element may further include a third material (e.g., TiO₂) that is stacked between the first material of the light emitting element 110 and the second material. The third material may have a refractive index that is between respective refractive indices of the first material and the second material. The transition element 150 may be tapered between a first width adjacent to the light emitting element 110 and a second width distal from the light emitting element 110, so as to couple optical modes into one or more layers of the underlying structures.

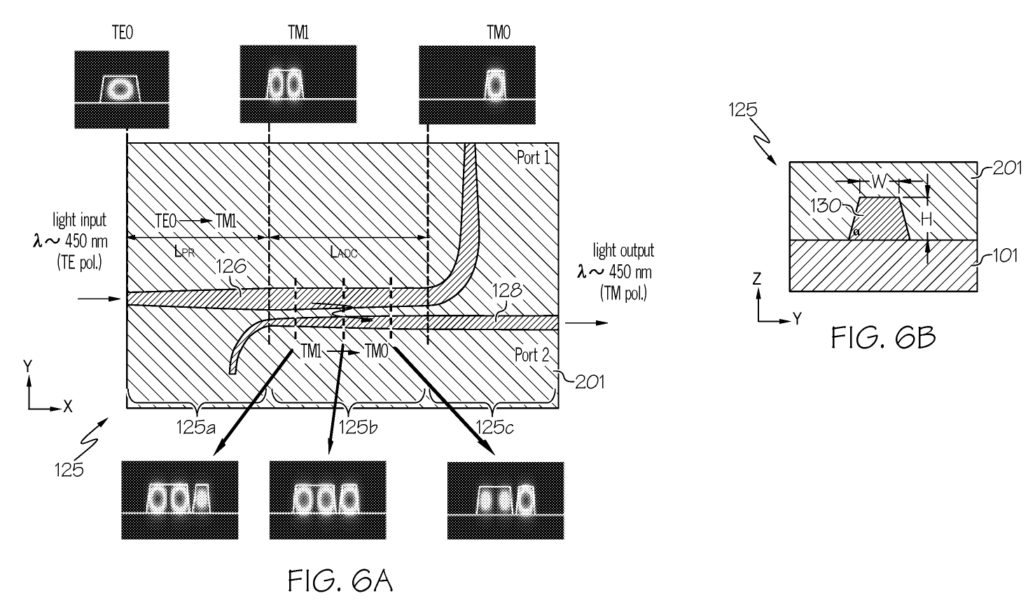

FIG. 6A is a schematic plan view and FIG. 6B is a schematic cross-sectional view of respective portions of a polarization management element 125 in a PIC according to some embodiments of the present disclosure. The widths W and/or heights H of the waveguide structure 130 shown in the cross-sectional view of FIG. 6B may be varied over the respective lengths of the stages shown in FIG. 6A, with the effects on the polarization of the light therein graphically illustrated in the inset images of FIG. 6A.

As shown in FIGS. 6A and 6B, a polarization management element 125 (shown as a polarization splitter rotator (PSR)) is implemented in a single crystal AlN-based optical structure 130/101 (including an AlN waveguide structure 130 on a sapphire substrate 101) based on a two-stage adiabatic mode evolution process. An insulating layer 201 (e.g., SiO₂) is provided on the PSR 125. In the first stage 125a (shown at the left side of the plan view of FIG. 6A), the AlN waveguide structure 130 includes a first waveguide segment 126 that adiabatically widens via a linear taper over its length L_{PR}, functioning as a polarization rotator (PR). That is, the first stage 125a includes a first portion of the first waveguide segment 126, which is tapered with increasing width toward the second stage 125b. Single-crystal AlN exhibits birefringence (e.g., Δn = ne – no = 0.051 at λ = 450 nm). An AlN waveguide structure 130 with a non-vertical sidewall angle α (e.g., an angle α in a range of about 60 to about 85 degrees, as shown in the cross-sectional view of FIG. 6B) provides a substantial mode crossing between a fundamental (zero-order) transverse electric polarization (TE0) mode and a first-order transverse magnetic polarization (TM1) mode at a proper or particular width in the first stage 125a. As a result, the input transverse electric polarization TE0 mode is converted first to a hybridized mode (e.g., an intermediate polarization) between TE0 and TM1, and finally fully to the first-order transverse magnetic polarization TM1 mode. That is, the input polarization orientation (or angle) is rotated from a first polarization orientation (TE0) to a second polarization orientation (TM1). The input polarization type or state (e.g., linear polarization) may be unaltered by the PSR element 125.

In the second stage 125b (shown at the middle of the plan view of FIG. 6A), an adiabatic directional coupler (ADC) is configured such that the mode index of the first-order transverse magnetic polarization TM1 mode in the upper arm 126 (i.e., the first waveguide segment) matches with the mode index of an output fundamental (zero-order) transverse magnetic polarization TM0 mode in the lower arm 128 (i.e., a second waveguide segment). Through evanescent wave coupling, the transverse magnetic polarization TM1 mode can be converted into the output transverse magnetic polarization TM0 mode over a length L_{ADC} of the second stage 125b, and extracted at the output port (Port 2; shown at the right side of the plan view of FIG. 6A) in a final stage 125c. Unconverted light will remain in the upper arm 126 and be extracted at Port 1. That is, the second stage 125b provides a directional coupler in which the second waveguide segment 128 extends along a second portion of the first waveguide segment 126 and is optically coupled thereto by evanescent wave coupling.

More generally, as shown in FIGS. 6A-6B, a polarization management element 125 is configured to alter a polarization of the light of a first frequency or wavelength range (as received from a light emitting element 110) from a first polarization TE to a second polarization TM, for input to a nonlinear optical element 120 that is configured to receive the light (having the first frequency or wavelength range and the second polarization) and generate light of a second frequency or wavelength range (e.g., UVC or far-UVC light). For example, the polarization management element 125 may be a polarization rotator of the second material that is optically coupled between the light emitting element 110 and the nonlinear optical element 120.

The polarization rotator 125 may include a first stage 125a having a first waveguide segment 126 that is configured to alter the first polarization to an intermediate polarization, and a second stage 125b having a second waveguide segment 128 that is configured to alter the intermediate polarization to the second polarization. The first stage 125a may include a first portion of the first waveguide segment 126 that is tapered with increasing width toward the second stage 125b, and the second stage 125b may include a directional coupler in which the second waveguide segment 128 extends along a second portion of the first waveguide segment 126. At least one of the first waveguide segment 126 and the second waveguide segment 128 may include a non-vertical sidewall angle.

Accordingly, using photonic integration and wafer bonding, embodiments of the present disclosure can achieve full integration of up to all photonic components that may be needed to implement far-UVC light emission on a single chip operating at UV wavelengths, thereby providing scalable miniaturized far-UVC light sources with significant reduction in cost, size, weight, and power (C-SWaP). Embodiments described herein may provide several advantages, including but not limited to:

In contrast with some SHG approaches using an external optical pump, embodiments of the present disclosure can directly integrate pump lasers (or other light emitting elements) on the PIC (e.g., via wafer bonding), which can greatly increase the optical coupling efficiency from the pump laser (or other light emitter) into the frequency doubler (or other nonlinear optical element) leading to reduced power consumption, more compact footprint, and improved performance. Furthermore, by integration of external optical feedback elements such as high-Q optical cavities, phase shifters, waveguide filters and mirrors, etc., single mode lasing with narrow linewidth and wide wavelength tunability can be achieved, which may achieve highly efficient tunable far-UVC light generation.

In some implementations, aluminum nitride (AlN) may be used as a material platform or optical structure for the spectral regime extending to the far-UVC, due to its wide bandgap (approximately 6.2 eV) and large second-order nonlinearity. AlN is transparent to light of wavelength above 200 nm suitable for UV photonics (e.g., 200 nm to 400 nm). Compared with polycrystalline AlN, single-crystal AlN epitaxially grown (e.g., on sapphire) may exhibit high film quality and thus low optical loss at UV wavelengths. Therefore, embodiments of the present disclosure may use single-crystal AlN on sapphire as a UV integrated photonic platform because it not only provides low-loss UV photonic elements and highly efficient SHG for far-UVC light in waveguide and resonator structures, but also exhibits capabilities of leveraging the PIC for implementing passive/active optoelectronic functionalities by integrating III-nitride based lasers and detectors.

For AlN’s crystalline structure, the c axis may be aligned perpendicular to the wafer substrate, which can lead to a larger value of second-order nonlinear coefficient for transverse magnetic (TM) modes as compared to the transverse electric (TE) modes. However, the output beam of semiconductor lasers is typically primarily TE mode. PICs according to embodiments of the present disclosure may therefore integrate a low-loss AlN-based polarization splitter rotator (PSR) (or other polarization management element) to efficiently convert the TE output mode of the on-chip blue laser into TM mode as an optical pump for far-UVC SHG with higher efficiency. PSR structures as described herein can be implemented in the AlN waveguide platform without using additional materials or other complex structures and/or process.

Embodiments of the present disclosure further include configurations of multi-stage adiabatic tapers (or other transition elements) as a low-loss interface between the group III-nitride (or other semiconductor) gain region and low loss AlN waveguides (or other nonlinear optical structures). Since there is a non-trivial difference of refractive index n between InGaN/GaN materials (n~2.6) and AlN (n~2.1), efficient direct optical mode transfer between the III-nitride gain region to AlN structures or waveguides with an adiabatic taper structure may present challenges. To address this issue, some embodiments described herein use a layer of dielectric material having a refractive index that is between the respective refractive indices of the group III-nitride materials and AlN as an auxiliary layer for an intermediate stage of adiabatic taper to achieve high optical coupling efficiency. For example, titanium oxide (TiO₂ may be one candidate of such dielectric materials, which may be transparent in the blue wavelength and can be deposited onto most substrates by physical vapor deposition (PVD) techniques. Moreover, the refractive index of TiO₂ an be flexibly tailored within a wide range between 2.3 and 2.5 by adjusting the process parameters of PVD, which may provide flexibility for the taper design. Multi-stage taper configurations as described herein can achieve high optical coupling efficiency of greater than about 90% per interface.

Laser beam output with narrow divergence may allow for beam shaping that may not be possible with some conventional approaches. In some embodiments, this may allow for incorporation of second-order diffraction gratings or etched mirrors to implement on-chip output couplers that are configured to disperse the light perpendicular to the surface of the chip, as an alternative to edge emission.

Laser beam output with narrow divergence may allow for beam shaping that may not be possible with some conventional approaches. In some embodiments, this may allow for incorporation of second-order diffraction gratings or etched mirrors to implement on-chip output couplers that are configured to disperse the light perpendicular to the surface of the chip, as an alternative to edge emission.

PIC devices according to embodiments described herein may be used to achieve mass production of high-efficiency, ultra-compact, low-cost solid-state far-UVC light sources, which may have potential for various applications including sensing, agriculture, water purification, and human-safe germicidal disinfection, In particular, some commercial applications in accordance with embodiments of the present disclosure can include elimination of pathogens from air and/or surfaces in any indoor spaces where humans congregate (e.g., airports, schools, hospitals, inpatient care centers, workplaces, etc.), as well as in transportation vehicles (e.g., subway cars, trains, taxis, airplanes) and agricultural settings (e.g., animal production facilities, meatpacking facilities, indoor greenhouses, etc.) as well as in the purification of water.

According to some embodiments, an ultraviolet (UV) light source comprises a substrate including a light emitting element, a polarization management element, and a nonlinear optical element integrated thereon in a solid-state structure. The light emitting element is configured to generate light of a first frequency, the polarization management element is configured to convert a polarization of the light of the first frequency from a first polarization to a second polarization, and the nonlinear optical element is configured to receive the light of the first frequency and having the second polarization from the polarization management element and generate far-UVC light of a second frequency from the light of the first frequency.

In some embodiments, the light emitting element may include a gain element that is configured to generate the light of the first frequency, and a transition element that extends between the gain element and a waveguide element.

In some embodiments, one or more of the transition element, the waveguide, and the polarization management element are implemented by one or more materials of the nonlinear optical element.

In some embodiments, the transition element may comprise one or more materials of the gain element and one or more materials of the nonlinear optical element, which may be tapered from adjacent the gain element toward the waveguide element.

In some embodiments, the transition element further comprises a dielectric material having refractive index between the respective refractive indices of the one or more materials of the gain element and one or more materials of the waveguide element.

In some embodiments, the polarization management element may be a polarization rotator element comprising one or more materials of the nonlinear optical element, and may be coupled between an output of the light emitting element and an input of the nonlinear optical element.

In some embodiments, the polarization rotator element may include a first stage including an upper arm comprising a tapered waveguide, and a second stage comprising a directional coupler including the upper arm and a lower arm extending along a portion of the upper arm. The first stage may be configured to convert the first polarization to an intermediate (e.g., first order) polarization. The second stage may be configured to convert the intermediate polarization to the second polarization.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as "example embodiment", "one embodiment" and "another embodiment" may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts.

The example embodiments will also be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

It will be understood that when an element is referred to or illustrated as being "on," "connected," or "coupled" to another element, it can be directly on, connected, or coupled to the other element, or intervening elements may be present. In contrast, when an element is referred to as being "directly on," "directly connected," or "directly coupled" to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. The terms “before” or “after” may refer to the arrangement of elements relative to the propagation path or direction of light.

Furthermore, relative terms, such as "lower" or "bottom" and "upper" or "top," may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the "lower" side of other elements would then be oriented on "upper" sides of the other elements. The exemplary term "lower", can therefore, encompass both an orientation of "lower" and "upper," depending on the particular orientation of the figure. Similarly, if the device in one of the figures is turned over, elements described as "below" or "beneath" other elements would then be oriented "above" the other elements. The exemplary terms "below" or "beneath" can, therefore, encompass both an orientation of above and below.

Elements described herein as “in-plane” may be arranged on or along the optical axis of the light propagation or a plane thereof. In contrast, “out-of-plane” elements may be arranged at angles to the plane of the optical axis of the light.

It will also be understood that the term "and/or" as used herein refers to and encompasses any and all possible combinations of one or more of the associated listed items. The term “at least one of...and” similarly encompasses any and all possible combinations of one or more of the associated listed items. It will be further understood that the terms “include,” “including,” "comprises," and/or "comprising," when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present invention described herein, and of the manner and process of making and using them, and shall support claims to any such combination or subcombination.

Although described herein with reference to various embodiments, it will be appreciated that further variations and modifications may be made within the scope and spirit of the principles of the invention. Although specific terms are employed, they are used in a generic and descriptive sense only and not for purposes of limitation, the scope of the present invention being set forth in the following claims.

1. A photonic integrated circuit (PIC), comprising:
a substrate;
a light emitting element comprising a first material on the substrate, wherein the light emitting element is configured to generate light of a first frequency or wavelength range; and
an optical structure comprising a second material on the substrate, wherein the optical structure is optically coupled to the light emitting element to receive the light of the first frequency or wavelength range therefrom and comprises a nonlinear optical element that is configured to generate UVC light of a second frequency or wavelength range, and wherein the optical structure further comprises at least one of:
a transition element that is tapered between a first width adjacent to the light emitting element and a second width distal from the light emitting element; and
a polarization management element that is configured to alter a first polarization of the light received from the light emitting element to a second polarization.

2. The PIC of claim 1, wherein the second material is native to the substrate, and the first material is non-native to the substrate.

3. The PIC of claim 1, wherein a portion of the transition element extends between the light emitting element and the substrate.

4. The PIC of claim 3, wherein the portion of the transition element further comprises a third material that is stacked between the first material of the light emitting element and the second material, the third material having a refractive index that is between respective refractive indices of the first material and the second material.

5. The PIC of claim 1, wherein the polarization management element comprises a first stage comprising first waveguide segment configured to alter the first polarization to an intermediate polarization, and a second stage comprising a second waveguide segment configured to alter the intermediate polarization to the second polarization.

6. The PIC of claim 5, wherein the first stage comprises a first portion of the first waveguide segment that is tapered with increasing width toward the second stage, and the second stage comprises a directional coupler in which the second waveguide segment extends along a second portion of the first waveguide segment.

7. The PIC of claim 6, wherein the first polarization is transverse electric (TE), and the second polarization is transverse magnetic (TM).

8. The PIC of claim 1, wherein the first material comprises a group-III nitride, and the second material comprises aluminum nitride.

9. A photonic integrated circuit (PIC), comprising:
a substrate;
a light emitting element on the substrate, wherein the light emitting element is configured to generate light of a first frequency or wavelength range;
a polarization management element on the substrate, wherein the polarization management element is configured to alter a polarization of the light of the first frequency or wavelength range from a first polarization to a second polarization; and
a nonlinear optical element on the substrate configured to receive the light of the first frequency or wavelength range and the second polarization and generate UVC light of a second frequency or wavelength range and the second polarization.

10. The PIC of claim 9, wherein the light emitting element comprises a first material, and at least one of the polarization management element and the nonlinear optical element comprises a second material that is different than the first material.

11. The PIC of claim 10, wherein the second material is native to the substrate, and the first material is non-native to the substrate.

12. The PIC of claim 10, further comprising:
at least one waveguide element comprising the second material on the substrate, wherein at least one waveguide element is optically coupled between the light emitting element and the nonlinear optical element.

13. The PIC of claim 12, wherein the light emitting element comprises a gain element including at least one quantum well of the first material, and further comprising:
a transition element comprising the second material on the substrate and optically coupled between the gain element and the at least one waveguide element, wherein the transition element is tapered between a first width adjacent to the gain element and a second width adjacent to the at least one waveguide element.

14. The PIC of claim 13, wherein a portion of the transition element extends between the light emitting element and the substrate.

15. The PIC of claim 14, wherein the portion of the transition element further comprises a third material having a refractive index that is between respective refractive indices of the first material and the second material.

16. The PIC of claim 13, further comprising:
a phase tuning structure comprising the second material and at least one microheater element on the substrate and optically coupled to the gain element.

17. The PIC of claim 10, wherein the polarization management element is a polarization rotator comprising the second material and optically coupled between the light emitting element and the nonlinear optical element.

18. The PIC of claim 17, wherein the polarization rotator comprises a first stage comprising first waveguide segment and configured to alter the first polarization to an intermediate polarization, and a second stage comprising a second waveguide segment and configured to alter the intermediate polarization to the second polarization.

19. The PIC of claim 18, wherein the first stage comprises a first portion of the first waveguide segment that is tapered with increasing width toward the second stage, and the second stage comprises a directional coupler in which the second waveguide segment extends along a second portion of the first waveguide segment.

20. The PIC of claim 18, wherein the first polarization is transverse electric (TE), the second polarization is transverse magnetic (TM), and at least one of the first waveguide segment and the second waveguide segment comprises a non-vertical sidewall angle.

21. The PIC of claim 10, wherein the second material comprises single-crystal aluminum nitride, and the substrate comprises sapphire.

22. A photonic integrated circuit (PIC), comprising:
a substrate;
a light emitting element comprising a first material on the substrate, wherein the light emitting element is configured to generate light of a first frequency or wavelength range;
a nonlinear optical element comprising a second material on the substrate, wherein the nonlinear optical element is configured to receive the light of the first frequency and generate UVC light of a second frequency or wavelength range; and
a transition element comprising the second material on the substrate, wherein the transition element tapered between a first width adjacent to the light emitting element and a second width distal from the light emitting element.

23. The PIC of claim 22, wherein the second material is native to the substrate, and the first material is non-native to the substrate.

24. The PIC of claim 22, wherein a portion of the transition element extends between the light emitting element and the substrate.

25. The PIC of claim 24, wherein the portion of the transition element further comprises a third material that is stacked between the first material of the light emitting element and the second material, the third material having a refractive index that is between respective refractive indices of the first material and the second material.

26. The PIC of claim 22, further comprising:
a polarization management element comprising the second material on the substrate and optically coupled between the transition element and the nonlinear optical element, wherein the polarization management element is configured to alter a polarization of the light of the first frequency or wavelength range from a first polarization to a second polarization.

27. The PIC of claim 22, wherein the first material comprises a group-III nitride, the second material comprises aluminum nitride, and the substrate comprises sapphire.
